(19) United States
(12) Patent Application Publication
(10) Pub. No.: US 2024/0160958 A1
(43) Pub. Date: May 16, 2024

(54) DATA DRIVEN SYSTEM AND DATA DRIVEN METHOD

(71) Applicants: Digiwin Software Co., Ltd, Shanghai (CN); DATA SYSTEMS CONSULTING CO., LTD., New Taipei City (TW)

(72) Inventors: Tzu-Chen Yeh, New Taipei City (TW); Hsiuchun Chen, New Taipei City (TW); Guoxin Sun, Shanghai (CN); Xiaoliang Ma, Shanghai (CN); Lei Feng, Shanghai (CN); Chu Yang Wang, Shanghai (CN)

(73) Assignees: Digiwin Software Co., Ltd, Shanghai (CN); DATA SYSTEMS CONSULTING CO., LTD., New Taipei City (TW)

(21) Appl. No.: 18/167,075

(22) Filed: Feb. 10, 2023

(30) Foreign Application Priority Data
Nov. 15, 2022 (CN) 202211426739.X

(51) Int. Cl. G06N 5/022

(52) U.S. Cl. CPC G06N 5/022

(57) ABSTRACT

A data driven system and a data driven method are provided. The data driven system includes a storage device and a processor. The storage device stores a data change sensing module, a data driven module, and a data footprint module. The processor is coupled to the storage device. The processor executes the data change sensing module to detect changed data. The processor executes the data driven module to obtain business data according to the changed data, and executes a task according to the business data to generate an execution result. The processor executes the data footprint module to record processing data generated during execution of the task.

### CROSS-REFERENCE TO RELATED APPLICATION

This application claims the priority benefit of China application serial no. 202211426739.X, filed on Nov. 15, 2022. The entirety of the above-mentioned patent application is hereby incorporated by reference herein and made a part of this specification.

### BACKGROUND

### Technical Field

This disclosure relates to a business data processing technology, in particular to a data driven system and a data driven method.

### Description of Related Art

Traditional business processing systems used in enterprise operations are usually recorded offline and entered into the system afterwards for business execution, which is delayed until after the business event occurs and cannot be executed automatically by the system. In this regard, the traditional business processing systems are usually human-driven, i.e., human beings make subjective judgments about what business to perform and how to perform it. In other words, the traditional business processing systems only assist people through the system, rather than being automatically judged and executed by the system. In addition, the traditional business processing systems also have the disadvantage that the business model is solidified and cannot adapt to the changes of various business scenarios. Moreover, since business operation involves human business processing experience and business processing knowledge, the transfer of business processing experience and business processing knowledge is one of the important issues in this field.

### SUMMARY

The disclosure is directed to a data driven system and a data driven method for automatically driving a corresponding business operation in response to an immediate data change.

According to an embodiment of the disclosure, the data driven system of the disclosure includes a storage device and a processor. The storage device stores a data change sensing module, a data driven module, and a data footprint module. The processor is coupled to the storage device. The processor executes the data change sensing module to detect changed data. The processor executes the data driven module to obtain business data according to the changed data, and executes a task according to the business data to generate an execution result. The processor executes the data footprint module to record processing data generated during execution of the task.

According to an embodiment of the disclosure, the data driven method of the disclosure includes the following. A data change sensing module is executed through a processor to detect changed data. A data driven module is executed through the processor to obtain business data according to the changed data, and a task is executed according to the business data to generate an execution result. A data footprint module is executed through the processor to record processing data generated during execution of the task.

Based on the above, the data driven system and the data driven method of the disclosure may automatically detect the changed data, and automatically execute a relevant task and generate the execution result by performing a relevant data driven operation according to the changed data. Moreover, the data driven system and the data driven method of the disclosure may also automatically record relevant processing data generated during execution of the relevant task. Thus, the data driven system and the data driven method of the disclosure enable automated and real-time enterprise management and business operation functions.

To make the aforementioned more comprehensive, several embodiments accompanied with drawings are described in detail as follows.

### BRIEF DESCRIPTION OF THE DRAWINGS

The accompanying drawings are included to provide a further understanding of the disclosure, and are incorporated in and constitute a part of this specification. The drawings illustrate exemplary embodiments of the disclosure and, together with the description, serve to explain the principles of the disclosure.

FIG. 1 is a schematic diagram of a circuit of a data drive system according to an embodiment of the disclosure.

FIG. 2 is a schematic diagram of a module of a data driven system according to an embodiment of the disclosure.

FIG. 3 is a flow chart of a data driven method according to an embodiment of the disclosure.

FIG. 4 is a schematic diagram of a system structure of a data driven system according to an embodiment of the disclosure.

FIG. 5 is a schematic diagram of a module structure of multiple modules according to an embodiment of the disclosure.

FIG. 6 is a schematic diagram of a module structure of a task engine module according to an embodiment of the disclosure.

### DESCRIPTION OF THE EMBODIMENTS

Reference will now be made in detail to exemplary embodiments of the disclosure, examples of the exemplary embodiments being illustrated in the accompanying drawings. Wherever possible, the same component symbols are used in the drawings and descriptions to represent the same or similar parts.

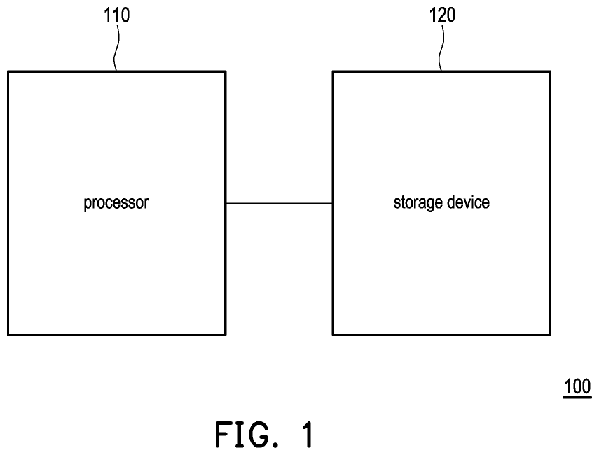

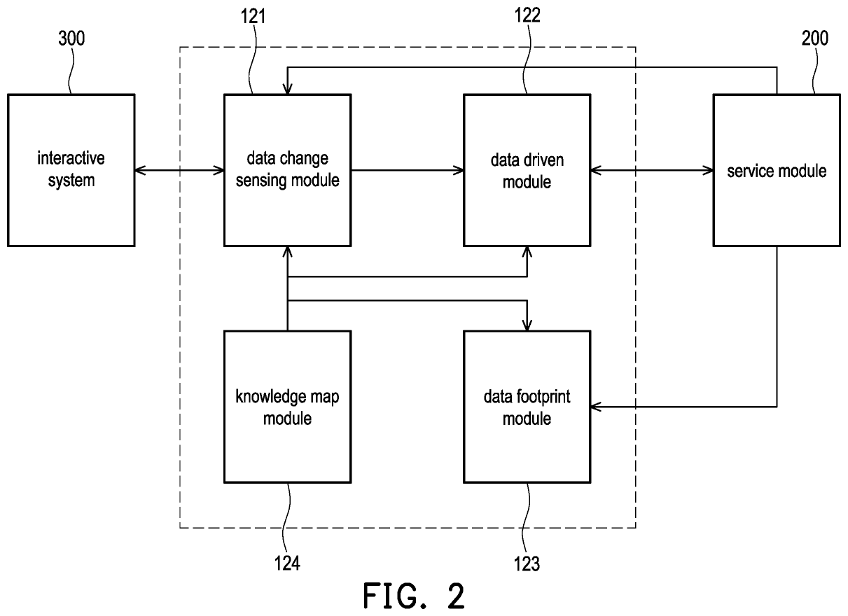

FIG. 1 is a schematic diagram of a circuit of a data drive system according to an embodiment of the disclosure. FIG. 2 is a schematic diagram of a module of a data driven system according to an embodiment of the disclosure. Referring to FIG. 1 and FIG. 2, a data driven system 100 includes a processor 110 and a storage device 120. The processor 110 is coupled to the storage device 120. In this embodiment, the processor 110 may include, for example, a central processing unit (CPU), or other programmable general-purpose or special-purpose microprocessors, digital signal processors (DSP), application-specific integrated circuits (ASIC), programmable logic device (PLD), other similar processing circuits, or a combination of these devices. The storage device 120 may include a memory and/or a database. The storage device 120 may store a data change sensing module 121, a data driven module 122, a data footprint module 123, and a knowledge map module 124. The storage device 120 may be, for example, a non-volatile memory (NVM). The storage device 120 may store relevant programs, modules, systems, or algorithms for implementing the embodiments of the disclosure for the processor 110 to access and execute to implement relevant functions and operations described in the embodiments of the disclosure. In this embodiment, the data driven system 100 may implement a special data driven framework.

In this embodiment, the data driven system 100 has a data driven framework composed of the data change sensing module 121, the data driven module 122, the data footprint module 123, and a knowledge map module 124. The data change sensing module 121 (or data detection engine), the data driven module 122, the data footprint module 123, and the knowledge map module 124 may be implemented, for example, in a programming language such as JSON (JavaScript Object Notation), Extensible Markup Language (XML), or YAML, but the disclosure is not limited thereto. In this embodiment, the data driven system 100 may be disposed or set up on a cloud server or a ground server, or may be disposed or set up on an internal information system or an external information system of an enterprise. The data driven system 100 may be connected to a business system of an enterprise. In one embodiment, the data change sensing module 121, the data driven module 122, the data footprint module 123, and the knowledge map module 124 may also be stored in different storage devices, and the processor 110 may also include multiple processing units with data processing capabilities. The processor 110 and the storage device 120 may also be disposed in different servers or devices. In this embodiment, the data driven system 100 may be wired and/or wirelessly connected to a service module 200 and an interactive system 300, or connected to the service module 200 and the interactive system 300 by means of an Intranet and/or Internet, etc.

In this embodiment, the service module 200 may include, for example, a customer relationship management (CRM) system, an enterprise resource planning (ERP) system, a manufacturing execution system (MES) and/or product lifecycle management (PLM) system, and other such business systems built within the enterprise, and may provide a variety of corresponding business service functions, and the services may be implemented, for example, in a form of platform as a service (PAAS) or software as a service (SAAS), but the disclosure is not limited thereto. In this embodiment, the interactive system 300 may include, for example, a user interface on a terminal device, a human-machine interface, or an operation interface of an automated system, etc., that may provide relevant task information, data, or requests to the user.

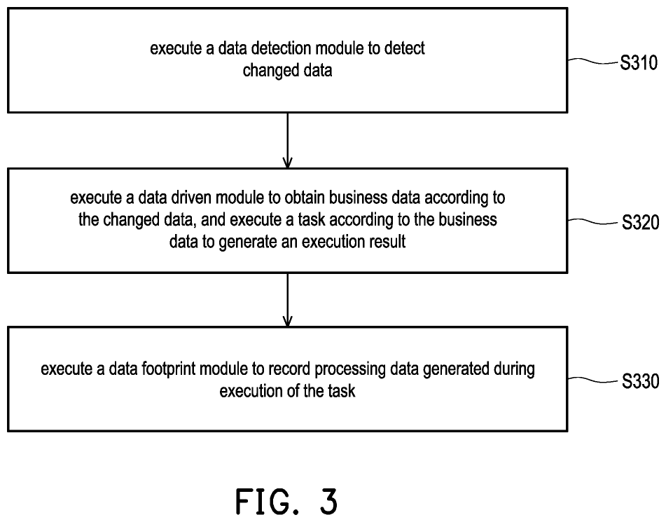

FIG. 3 is a flow chart of a data driven method according to an embodiment of the disclosure. Referring to FIG. 1 to FIG. 3, in this embodiment, the data driven system 100 may execute the following steps S310 to S330 to implement data driving. In step S310, the processor 110 may execute the data change sensing module 121 to detect changed data. In this embodiment, the data change sensing module 121 may detect an external service module 200 according to a detection definition provided by the knowledge map module 124 to determine whether the changed data occurs. When the data change sensing module 121 detects the changed data, in step S320, the processor 110 may execute the data driven module 122 to obtain business data according to the changed data, and execute a task according to the business data to generate an execution result. In this embodiment, the data driven module 122 may query and analyze a project task definition to the knowledge map module 124 according to the business data, and execute a corresponding task according to a corresponding definition and rule. In step S330, the processor 110 may execute the data footprint module 123 to record processing data generated during execution of the task. In this embodiment, the data footprint module 123 may record relevant processing data according to the business data and/or metadata definition provided by the knowledge map module 124. Thus, the data driven system 100 according to this embodiment may automatically drive a corresponding business operation in response to an immediate business data change.

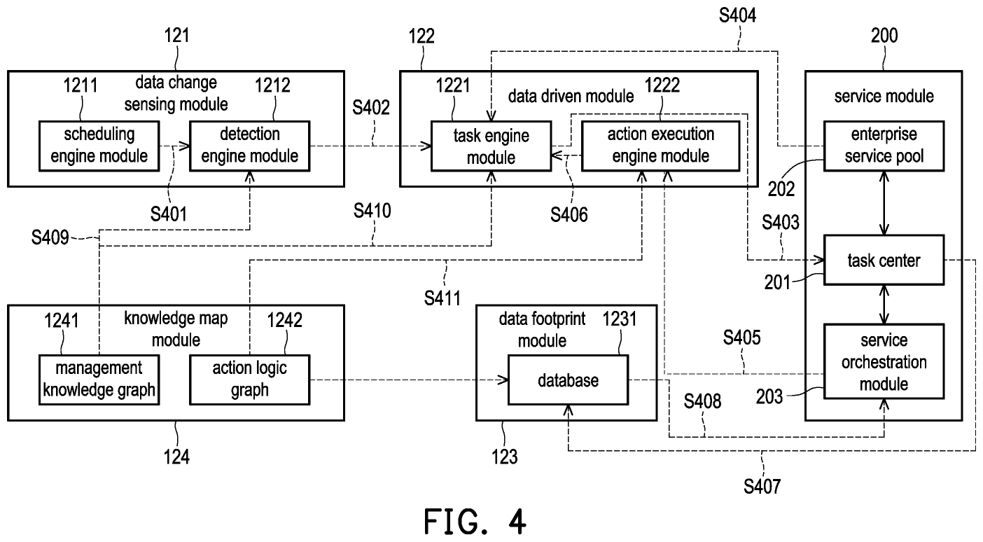

FIG. 4 is a schematic diagram of a system structure of a data driven system according to an embodiment of the disclosure. Referring to FIG. 2 and FIG. 4, the embodiment in FIG. 4 may be a further illustration of the specific system structure and the specific operation method of the embodiment in FIG. 2. In this embodiment, the data change sensing module 121 includes a scheduling engine module 1211 and a detection engine module 1212. The data driven module 122 includes a task engine module 1221 and a data pull engine module 1222 (or action execution engine). The data footprint module 123 includes a database 1231. The knowledge map module 124 includes a management knowledge graph 1241 and an action logic graph 1242. The service module 200 includes a task center 201, an enterprise service pool 202, and a service orchestration module 203. The enterprise service pool 202 may be used, for example, to provide various business services such as CRM system, ERP system, MES and/or PLM system, and the business services have multiple business data. It should be noted that operations S401 to S411 described below are not executed in full sequence, but mainly describe relevant operations and functions that can be executed and implemented by each module. In this embodiment, the enterprise business execution process and the experience of business management may be expressed through knowledge graphs. Execution logic and an execution rule obtained by the data driven module 122 are mainly models of various business activities in the enterprise and their association with data changes, and are used to rule out which subsequent task(s) (business activities) the system should drive the execution of when what data changes.

In operation S401, the scheduling engine module 1211 may periodically initiate a detection instance to trigger the detection engine module 1212 according to a corresponding scheduling definition to execute a data change sensing operation according to a detection definition matching the scheduling definition. In this regard, in operation S409, the management knowledge graph 1241 may provide a detection definition to the data change sensing module 121. The detection engine module 1212 may obtain data of a business system through a service module 200, and determines a change in the data of the business system to detect the changed data. In this embodiment, the data of the business system may include the data in an information system deployed at a ground end (within the enterprise), such as enterprise resource planning (ERP) system, manufacturing execution system (MES), or customer relationship management (CRM) system, etc., which may allow the detection engine module 1212 to call the services of the ground end system through the service module 200 through the service registration and calling capability of the service module 200, so as to obtain steady-state data through the service of the ground end system. In one embodiment, the data of the business system may also include business data provided by an associated application service or middle platform (middle-end) service of Software as a Service (SaaS) deployed in the cloud.

The detection engine module 1212 may analyze a detection operation logic in the detection definition to find changed business data. That is, the detection engine module 1212 may detect whether the business data of the various business services in the enterprise service pool 202 changes. In operation S402, the detection engine module 1212 may send the changed data to the task engine module 1221 to initiate corresponding task processing.

In operation S403, the data driven module 122 may convert the changed data into task data according to a data management model, and provide the task data to the task center 201 of the service module 200, so that the task center 201 may query or access the enterprise service pool 202 according to the task data to perform relevant tasks (e.g., execute one or more services). In this regard, in step S410, the management knowledge graph 1241 may provide the data management model to the task engine module 1221 of the data driven module 122, so that the task engine module 1221 of the data driven module 122 may obtain the execution logic and the execution rule according to the data management model, and execute relevant tasks in the enterprise service pool 202 according to the execution logic and the execution rule. The management knowledge graph 1241 may use the data management model in a form of data-task-data to encapsulate the knowledge of enterprise business flow to solve the problem of how to arrange tasks in enterprise management to achieve business goals and how to dynamically adjust tasks when changes occur. And, based on the knowledge, the knowledge map module 124 may provide the task engine module 1221 with the task definition that can achieve the goal, and the task engine module 1221 executes relevant tasks according to specific execution logic and rule defined in the tasks.

In operation S404, the task engine module 1221 may obtain corresponding business data according to the task data returned back through relevant services executed by the enterprise service pool 202 of the service module 200, and may generate an execution result according to the business data. Moreover, in operation S405, when the task engine module 1221 needs to obtain business data or execute a specific business operation during execution, the task engine module 1221 may complete the call through the data pull engine module 1222. In this regard, the service orchestration module 203 may call the service, and sequentially access relevant business processing interface to implement business logic processing, and the service orchestration module 203 may return the business data of the processing result to the data pull engine module 1222. In operation S406, the data pull engine module 1222 may process the business data according to the action logic model to generate processed business data to the task engine module 1221, so that the task engine module 1221 may generate an another execution result. In this regard, in step S411, the action logic graph 1242 may provide the action logic model to the data pull engine module 1222. The action logic graph 1242 may provide an instance of the action logic model to the data pull engine module 1222, and the data pull engine module 1222 may execute a sequence of actions (e.g., call services and/or tasks, etc.) according to a definition of the action logic graph 1242. In this embodiment, the action logic graph 1242 abstracts the business logic into an action as one primary node type in the graph, and adds data as another primary node type. The action logic graph 1242 may describe the relationship between actions and data through edges that connect action nodes to data nodes.

In addition, in operation S407, when the task data generated by the relevant tasks executed by the task engine module 1221 needs to be recorded, the task engine module 1221 may provide the task data to the task center 201, and push the task data to the data footprint module 123 through the task center 201 to record in the database 1231. In this regard, the management knowledge graph 1241 and the action logic graph 1242 may provide the business data and/or metadata definition to the data footprint module 123, so that the data footprint module 123 may periodically record the relevant processing data. In this way, in operation S408, the service orchestration module 203 may use previous task data recorded in the database 1231 for the current call service in the subsequent call service without re-executing the previously performed task operation, thus effectively improving the efficiency and execution speed of the service call. In this embodiment, the processing data recorded by the data footprint module 123 may include what tasks the data was processed for, what actions (e.g., application programming interface (API)) were taken, and what transformations occurred. For example, purchase requisition data is converted to purchase data through a requisition to purchase task (a task through which the data was processed), and a conversion from the purchase requisition data to the purchase data is implemented through a requisition to purchase API called from within the requisition to purchase task. In this way, the data footprint module 123 carries a data identifier when recording footprint to identify which purchase data the purchase requisition data has been converted to after the requisition to purchase.

For example, if the changed data is a purchase order, the scheduling engine module 1211 may initiate a detection instance at a specific time of day according to the scheduling definition, so as to detect whether there is new purchase order information through the detection engine module 1212. Next, when the detection engine module 1212 adds the purchase order information, the detection engine module 1212 may initiate a purchase issuance project, and call the service through the enterprise service pool 202 to obtain purchaser information corresponding to the purchase order. Then, the task engine module 1221 may send a purchase sign-off task card to a corresponding purchaser (task) through the interactive system 300. Moreover, during the task execution process of the task engine module 1221, relevant business may be recorded into the data footprint module 1231. In this way, the data footprint module 1231 may create a record of the relationship between the task data received this time and historical operations of the same business previously performed, thus continuously recording business data development. Finally, the purchaser may obtain supplier information corresponding to the purchase order through the service orchestration module 203 after submission through the interactive system 300, and send an email to the corresponding supplier for purchasing. Then, when the detection engine module 1212 detects a purchase change again (the changed data is a changed purchase order), the detection engine module 1212 may initiate a purchase change project by analogy with the process of initiating the purchase issuance project, and the task engine module 1221 uses the data footprint module 1231 to find the ongoing purchase sign-off task corresponding to the previously recorded purchase order, so as to perform a corresponding modification or closure action. Thus, the data driven system according to this embodiment may automatically detect the changed data to initiate corresponding task operations, and the relevant business execution may be carried out efficiently.

It is further noted that the task is a complete segment of a series of activities that are processed for the business, and changes a state or structure of input data before outputting the input data, such as the task card provided to the user as described above (e.g., the purchase sign-off task card) is generated from the activities. In this regard, the activity is a smallest matter that can be completed in a single step and is not subdividable. Illustrated by a data management model in the form of (input) data-task-(output) data used to encapsulate knowledge of the enterprise business flow, elements of the data (input data and output data) include data types (e.g., purchase requisition data), data state characteristics, and data structures. The elements of the task include input data and output data, and include the activity. For example, the input data may be a purchase order that has been signed and confirmed. The output data may be a purchase order that has been responded to. The task may include multiple activities, such as obtaining supplier information, sending an email, and responding to a delivery date. Thus, the input data may be input to the task, and the task may output corresponding output data. In other words, the task engine module 1221 may execute the corresponding task according to the changed data to automatically execute the business task through the data management model and obtain the business data.

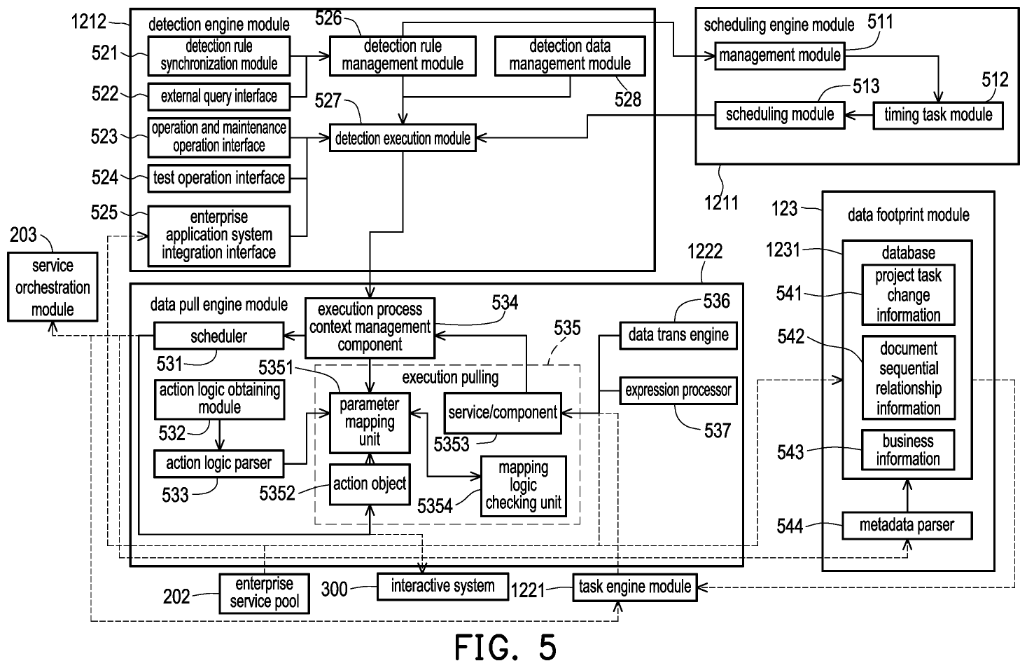

FIG. 5 is a schematic diagram of a module structure of multiple modules according to an embodiment of the disclosure. Referring to FIG. 5, this embodiment further illustrates a specific module structure of the scheduling engine module 1211, the detection engine module 1212, the data pull engine module 1222, and the data footprint module 123. In this embodiment, the scheduling engine module 1211 may include a management module 511, a timing task module 512, and a scheduling module 513. In this embodiment, the detection engine module 1212 may include a detection rule synchronization module 521, an external query interface 522, an operation and maintenance operation interface 523, a test operation interface 524, an enterprise application system integration interface 525, a detection rule management module 526, a detection execution module 527, and a detection data management module 528. In this embodiment, the data pull engine module 1222 may include a scheduler 531, an action logic obtaining module 532, an action logic parser 533, an execution process context management component 534, a parameter mapping unit 5351, an action object 5352, a service/component 5353, a mapping logic checking unit 5354, a data conversion engine 536, and an expression processor 537. The parameter mapping unit 5351, the action object 5352, the service/component 5353, and the mapping logic checking unit 5354 may form an execution pulling 523 (multiple execution pullings may be performed). In this embodiment, the data footprint module 123 may include a database 1231 and a metadata parser 544. The database 1231 may store project task change information 541, document sequential relationship information 542, and business information 543.

In this embodiment, the management module 511 may obtain a relevant detection definition from the detection rule management module 526 of the detection engine module 1212, and manage the relevant detection definition and scheduling definition to provide to the timing task module 512. The timing task module 512 may implement timing scheduling according to the detection definition and scheduling definition, so as to notify the scheduling module 513. The scheduling module 513 may periodically initiate a corresponding detection rule to the detection execution module 527 of the detection engine module 1212, so that the detection execution module 527 analyzes the detection rule and generates a corresponding detection instruction, and then performs corresponding data filtering or data conversion, etc. on the execution result according to the detection rule.

In this embodiment, the detection rule synchronization module 521 may obtain the detection definition from the knowledge map module, or obtain the detection definition from the external query interface 522. The detection data management module 528 may record the detection result as reference data required to be filtered in a next detection rule. The operation and maintenance operation interface 523 and the test operation interface 524 may provide an operation instruction to the detection execution module 527 to perform an operation and maintenance operation or test operation. The enterprise application system integration interface 525 may obtain the changed data from the enterprise service pool 202, and provide the changed data to the detection execution module 527.

In this embodiment, the execution process context management component 534 may obtain the changed data from the detection execution module 527, and may manage intermediate data and initial data generated during execution of action logic. A data trans engine may perform transformation or calculation with business logic on data or structure, and provide processed data to the service/component 5353 of the execution pulling 535. The expression processor 537 may support fast expression calculation with relatively simple logic, and may provide an expression execution result to the service/component 5353 of the execution pulling 523. The service/component 5353 of the execution pulling 523 may also obtain mechanism data from the knowledge map module and task data from the task engine module 1221. The service/component 5353 of the execution pulling 523 may execute relevant service operations according to the data to generate a call result to the execution process context management component 534. The execution process context management component 534 may provide the execution result to the scheduler 531. The scheduler 531 may be responsible for executing pulling of actions during the execution of the action logic. The mapping logic checking unit 5354 of the execution pulling 523 may check validity of data and structure of a parameter mapping process. The action object 5352 may be determined by front-end business data provided by the interactive system 300 or execution process data provided by the scheduler 531. The parameter mapping unit 5351 of the execution pulling 523 may assemble parameters and structures of a currently accessed component according to parameter mapping logic. The action logic obtaining module 532 may analyze the initial data of this execution, and obtain a logic model instance from the action logic graph of the knowledge map module to provide to the action logic parser 533. The action logic parser 533 analyzes an action logic model instance to provide an analyzed logic model instance to the parameter mapping unit 5351. The scheduler 531 may provide the execution result to the service orchestration module 203, the interactive system 300, and/or the task engine module 1221.

In this embodiment, the metadata parser 544 may obtain the business data from the interactive system 300. The metadata parser 544 may analyze the business data, and identify the project task change information 541 (information on project task status changes in the business data), the document sequential relationship information 542 (data and relationship information before and after document conversion in the business data) and the business information 543 (information about business primary key in the business data), etc., and stored in the database 1231. The database 1231 of the data footprint module 123 may provide historical data (namely, historical identification project task change information 541, the document sequential relationship information 542, and the business information 543) to the task engine module 1221.

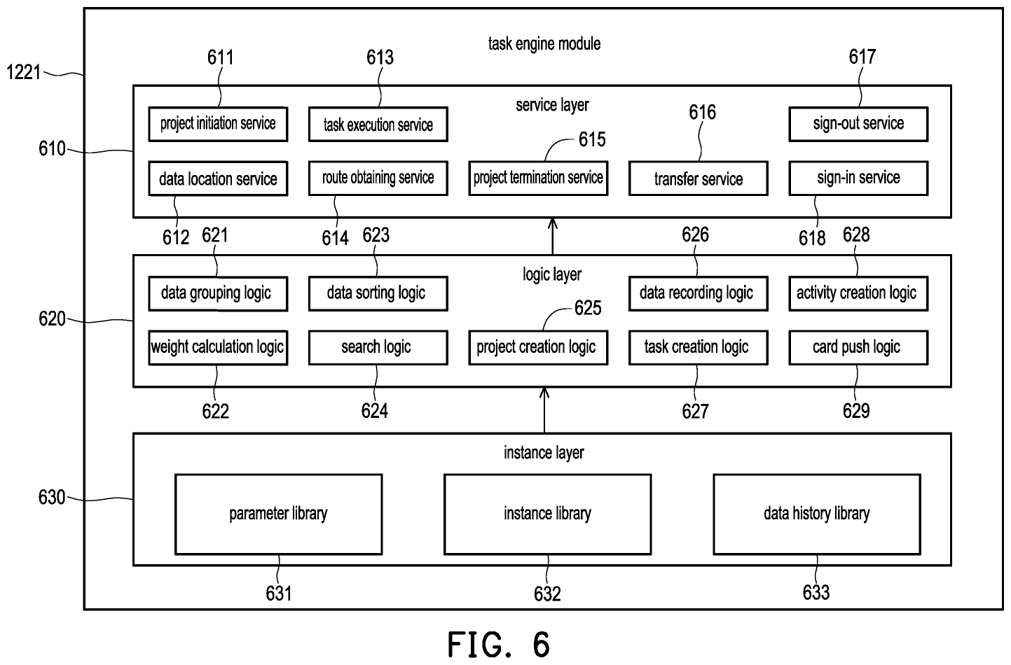

FIG. 6 is a schematic diagram of a module structure of a task engine module according to an embodiment of the disclosure. Referring to FIG. 6, this embodiment further illustrates a specific module structure of the task engine module 1221. In this embodiment, the task engine module 1221 may be constructed by a service layer 610, a logic layer 620, and an instance layer 630. The service layer 610 may include a project initiation service 611, a data location service 612, a task execution service 613, a route obtaining service 614, a project termination service 615, a transfer service 616, a sign-out service 617, and a sign-in service 618. The logic layer 620 may include data grouping logic 621, weight calculation logic 622, data sorting logic 623, search logic 624, project creation logic 625, data recording logic 626, task creation logic 627, activity creation logic 628, and card push logic 629. The instance layer 630 may include a parameter library 631, an instance library 632, and a data history library 633.

In this embodiment, the project initiation service 611 may provide a service to initiate a project after the detection engine detects the changed data. The data location service 612 may query tasks that the business data has gone through, and may determine which task the data is staying on. The task execution service 613 is the core of the engine, and may execute the execution logic for each type of task (e.g., automated or manual) according to a model definition. The route obtaining service 614 may obtain a knowledge map (KM) definition and calculate possible task routes executed subsequently by the data. The project termination service 615 may provide data execution to a target state to trigger a shutting down project logic service. The transfer service 616 may be used for task transfer performed by manual type tasks (e.g., sign-off lever transfer of sign-off type tasks). The sign-out service 617 and the sign-in service 618 may be logically processed for the sign-off type tasks.

In this embodiment, the data grouping logic 621 may group data output after the execution of the task according to certain rules or mechanisms. The weight calculation logic 622 may provide weight calculation services to find out a best data execution route. The data sorting logic 623 may sort out data to be output according to defined rules or mechanisms to bring the data to an output-ready state. The search logic 624 may provide budget logic for an upper-level data location service. The project creation logic 625 may create the execution logic of the project. The data recording logic 626 may provide a subsequent data location service for experienced task engine data that needs to be recorded. The task creation logic 627 may provide creation task logic required by the service layer 610 during a task execution service process. The activity creation logic 628 may provide a creating activity service required to provide during the task execution process of the service layer 610. The card push logic 629 may interact with a task center for information such as data and task status during task execution.

In this embodiment, the parameter library 631 may include project parameters and task parameters. The project parameters may refer to parameter variables that are generated at the time of project initiation and are available for use in project process task execution. The task parameters may refer to parameter variables that are generated at the time of task creation and are available for use by activities during task execution process. The instance library 632 may include project instances, task instances, and activity instances. The project instances may be used to implement project data persistence. The task instances may be used to implement task data persistence. The activity instances may be used to implement activity data persistence. The data history library 633 may include data histories. The data histories may provide data location services, data tasks to find persistent data.

It should be noted that the data driven system of the disclosure is applied in the field of small data driven. In detail, the data driven system of the disclosure may be used to fully digitize each link, element, or state of offline business activities (operations) in enterprise business activities, and combine the enterprise management knowledge for data association and task content correspondence.

To sum up, when performing business activities, the data driven system of the disclosure may automatically focuses on (detects) data changes, and automatically drive tasks directly related to the results of data changes based on the data associations provided by enterprise management knowledge. Moreover, when new data is generated or the data is changed after the task is executed, the data driven system of the disclosure may cyclically change the data through the operation, so as to achieve a final business goal. The data driven system of the disclosure may also dynamically adapt to changes in data as the task proceeds to recommend the most appropriate task. The data driven system of the disclosure may also automatically detect business data changes based on the knowledge map. The data driven system of the disclosure may be applied to scenarios such as, but not limited to, incoming material inspection, equipment maintenance, inventory level management, and energy conservation management.

It will be apparent to those skilled in the art that various modifications and variations can be made to the disclosed embodiments without departing from the scope or spirit of the disclosure. In view of the forthcoming, it is intended that the disclosure covers modifications and variations provided that they fall within the scope of the following claims and their equivalents.

What is claimed is:

1. A data driven system comprising:
a storage device storing a data change sensing module, a data driven module, and a data footprint module; and
a processor coupled to the storage device,
wherein the processor executes the data change sensing module to detect changed data,
wherein the processor executes the data driven module to obtain business data according to the changed data, and executes a task according to the business data to generate an execution result.

2. The data driven system according to claim 1, wherein the storage device further stores a knowledge map module, and the knowledge map module comprises a management knowledge graph, wherein the management knowledge graph provides a detection definition to the data change sensing module.

3. The data driven system according to claim 1, wherein the data driven module comprises a task engine module, and the data driven module converts the changed data into task data, such that the task engine module obtains the business data through a service module according to the task data to generate the execution result according to the business data.

4. The data driven system according to claim 3, wherein the data driven module further comprises a data pull engine module, and the data pull engine module processes the business data according to an action logic model to generate processed business data to the task engine module, such that the task engine module generates an another execution result according to the processed business data.

5. The data driven system according to claim 4, wherein the storage device further stores a knowledge map module, and the knowledge map module comprises an action logic graph, wherein the action logic graph provides the action logic model to the data pull engine module.

6. The data driven system according to claim 4, wherein the service module comprises a service orchestration module, and the service orchestration module provides the business data.

7. The data driven system according to claim 1, wherein the storage device further stores a knowledge map module, and the knowledge map module comprises a management knowledge graph, wherein the management knowledge graph provides a data management model to the data driven module, such that the data driven module obtains execution logic and an execution rule according to the data management model, and executes the task according to the execution logic and the execution rule.

8. The data driven system according to claim 1, wherein the data change sensing module comprises a scheduling engine module and a detection engine module, and the scheduling engine module periodically initiates a detection instance to trigger the detection engine module according to a corresponding scheduling definition to execute a data change sensing operation according to a detection definition matching the scheduling definition.

9. The data driven system according to claim 8, wherein the detection engine module obtains data of a business system through a service module, and determines a change in the data of the business system to detect the changed data.

10. The data driven system according to claim 1, wherein the processor executes the data footprint module to record processing data generated during execution of the task.

11. A data driven method comprising:
executing a data change sensing module through a processor to detect changed data; and
executing a data driven module through the processor to obtain business data according to the changed data, and executing a task according to the business data to generate an execution result.

12. The data driven method according to claim 11, wherein the storage device further stores a knowledge map module, and the knowledge map module comprises a management knowledge graph, wherein the management knowledge graph provides a detection definition to the data change sensing module.

13. The data driven method according to claim 11, wherein the data driven module comprises a task engine module, and generating the execution result comprises:
converting the changed data into task data through the data driven module, such that the task engine module obtains the business data through a service module according to the task data to generate the execution result according to the business data.

14. The data driven method according to claim 13, wherein the data driven module further comprises a data pull engine module, and generating the execution result comprises:
processing the business data through the data pull engine module according to an action logic model to generate processed business data to the task engine module, such that the task engine module generates an another execution result according to the processed business data.

15. The data driven method according to claim 14, wherein the storage device further stores a knowledge map module, and the knowledge map module comprises an action logic graph, wherein the action logic graph provides the action logic model to the data pull engine module.

16. The data driven method according to claim 14, wherein the service module comprises a service orchestration module, and the service orchestration module provides the business data.

17. The data driven method according to claim 11, wherein the storage device further stores a knowledge map module, and the knowledge map module comprises a management knowledge graph, wherein the management knowledge graph provides a data management model to the data driven module, and executing the task comprises:
obtaining execution logic and an execution rule through the data driven module according to the data management model, and executing the task according to the execution logic and the execution rule.

18. The data driven method according to claim 11, wherein the data change sensing module comprises a scheduling engine module and a detection engine module, and detecting the changed data comprises:
periodically initiating a detection instance through the scheduling engine module to trigger the detection engine module according to a corresponding scheduling definition to execute a data change sensing operation according to a detection definition matching the scheduling definition.

19. The data driven method according to claim 18, wherein the data change sensing operation comprises:
obtaining data of a business system through the detection engine module through a service module, and determining a change in the data of the business system to detect the changed data.

20. The data driven method according to claim 11 further comprising:
executing a data footprint module through the processor to record processing data generated during execution of the task.
